(19) United States
(12) Patent Application Publication
(10) Pub. No.: US 2026/0307747 A1
(43) Pub. Date: Oct. 8, 2026

(54) DETECTING CONDITIONS FOR: STARTING A SELF-BALANCING FEATURE; AND DEACTIVATING A SELF BALANCING FEATURE OF A VEHICLE WITH SELF-BALANCING CAPABILITIES, AND IMPLEMENTATION BASED ON THE RESULTS THEREOF

(71) Applicants: Vikas PODDAR, Mumbai (IN); Ashutosh UPADHYAY, Mumbai (IN)

(72) Inventors: Vikas PODDAR, Mumbai (IN); Ashutosh UPADHYAY, Mumbai (IN)

(21) Appl. No.: 19/519,045

(22) PCT Filed: Sep. 12, 2024
(86) PCT No.: PCT/IN2024/051719

§ 371 Date: Mar. 12, 2026

(30) Foreign Application Priority Data
Sep. 12, 2023 (IN) 202321061178

(51) Int. Cl. B62D 37/06

(52) U.S. Cl. CPC B62D 37/06

(57) ABSTRACT

Detecting Conditions For: Starting a Self-Balancing Feature; and Deactivating a Self Balancing Feature of a Vehicle with Self-Balancing Capabilities, and Implementation Based on the Results thereof A system and method for detecting conditions for: starting a self-balancing feature, and deactivating a self balancing feature; either/both of a vehicle with self-balancing capabilities, and implementation based on the results thereof is described In one embodiment the application of such system may lead to creation of a conditional self-balancing system. In another embodiment, this may be added as a safety mechanism to pre-existing self-balancing systems.

### TECHNICAL FIELD

The present subject matter in general, to auto balancing systems for vehicles and more specifically, to a safety and test mechanism in the balancing solution for applications in two wheelers.

### BACKGROUND OF THE INVENTION

Two wheelers are widely used for their small size, fuel economy and ease of use. Two-wheeled vehicles have many advantages over other concepts such as smaller size, more efficient, and more maneuverable. These advantages come with the disadvantages such as the lack of ease for stability, and safety. One of the most challenging problems for overcoming these disadvantages is to keep the two wheeler balanced. To improve the stability and safety of a two-wheeled vehicle, solutions have been suggested in the prior art. One such solution is the use of Control Moment Gyroscope auto balancing. The problem of auto balancing of an inherently unstable body is a classical control theory problem. The idea of using the gyroscope effect for auto-balancing is part of a much broader effort to implement with this invention. As the vehicle leans from its upright position, we expect to generate sufficient gyroscopic reaction moments to bring the vehicle back and auto-balance it.

The control moment gyroscope (CMG) is one of the angular momentum exchange devices which is the application of this research that can produce large output torque on the body. It consists of the motor-driven rotor and gimbal. The spin axis of the flywheel can vary about a perpendicular axis to its spin axis (the gimbal axis). Complex dynamic derivations are used to find a relationship between the torque input to the gimbal axis and a desired output torque on the body. The rate of change of angular momentum between the CMG and the body is dependent on the spin axis velocity(gimbal velocity). However, two-wheeler riders can greatly benefit from the comfort and safety provided by a CMG based Auto balancing device.

However, the auto balancing systems may suffer from the need for excessive computational systems for balancing a vehicle in various operating conditions. This may be considered as one of the primary reasons for delayed implementation of such systems to publicly available self balancing systems for a vehicle. This is more particularly true for a two wheeler system.

There is therefore a need for an advanced system for allowing balancing of a vehicle depending on the state of the operation of a vehicle.

### SUMMARY OF THE INVENTION

The present invention discloses a system for detecting optimum conditions for use of an auto balancing system. In one aspect of the invention, the system is applied to a two wheeler self balancing system utilizing a CMG (Control Moment Gyroscope) module generating a torque to keep the two wheeler balanced. In one embodiment, a system for detecting conditions leading to disabling of an auto balancing system are disclosed.

Further, an aspect of the invention is to provide for manual indication to a user based on detection of above conditions. Another aspect is to activate or deactivate a self-balancing system automatically without requiring a user input. In yet another aspect the user may provide a prior approval of automatic activation of an auto balancing system, when such conditions are achieved. In yet another aspect the user may provide a prior approval of automatic deactivation of an auto balancing system, when such conditions are achieved.

In one embodiment disclosed herein, a control moment gyroscope (CMG) working in conjunction with the disclosed auto balancing system, is capable of generating strong restoration torque with a relatively small-sized flywheel by changing the direction of flywheel momentum. The CMG may be used for active balancing of a two wheeler that has unstable equilibrium points in its dynamics. A single CMG generates not only the restoration torque component but also an additional unwanted torque component. In contrast, two CMG with opposite spin and precision cancels out the unwanted torque and doubles the restoration torque. Before, the activation/deactivation processes however a check is run for optimum conditions. In one embodiment, the optimum conditions may be different for different scenarios. For example, the optimum condition for a self-balancing activation may be different than the threshold conditions that call for deactivation of a self-balancing system.

In one embodiment, the method for detecting the operability, and management of a self-balancing system that is based on a control moment gyroscope, of a two-wheeler vehicle, the method comprising the steps of: intermittently checking, while the two-wheeler vehicle's self-balancing system is OFF, whether a current vehicular velocity is less than a first vehicular velocity threshold; intermittently checking, while the two-wheeler vehicle's self-balancing system is OFF, whether a current vehicle turn rate is less than a first vehicular turn rate; intermittently checking, while the two-wheeler vehicle's self-balancing system is OFF, whether the self-balancing system is within a first range of safe operating conditions for balancing; turning ON the self-balancing feature of the self-balancing system based on a positive determination of step 1a, 1b and 1c; intermittently checking, while the two-wheeler vehicle's self-balancing system is ON, whether the self-balancing system is within a second range of safe operating conditions for balancing; intermittently checking, while the two-wheeler vehicle's self-balancing system is ON, whether a current vehicular velocity is less than a second vehicular velocity threshold; intermittently checking, while the two-wheeler vehicle's self-balancing system is ON, whether a current vehicle turn rate is less than a second vehicular turn rate; and, turning OFF the self-balancing feature of the self-balancing system based on a negative result of step 1e, 1f, or 1g.

In another embodiment, the method for detecting the operability, and management of a self-balancing system that is based on a control moment gyroscope, of a two-wheeler vehicle wherein the first vehicular turn rate is same as second vehicular turn rate.

In one embodiment, the method for detecting the operability, and management of a self-balancing system that is based on a control moment gyroscope, of a two-wheeler vehicle, wherein the first vehicular turn rate is different that the second vehicular turn rate.

As per one embodiment, the method for detecting the operability, and management of a self-balancing system that is based on a control moment gyroscope, of a two-wheeler vehicle wherein the first vehicular velocity threshold is same as second vehicular velocity threshold.

In one embodiment the method for detecting the operability, and management of a self-balancing system that is based on a control moment gyroscope, of a two-wheeler vehicle wherein the first vehicular velocity threshold is different that the second vehicular velocity threshold.

In one embodiment, the method for detecting the operability, and management of a self-balancing system that is based on a control moment gyroscope, of a two-wheeler vehicle wherein the first range of safe operating conditions is same as the second range of safe operating conditions.

In one embodiment, the method for detecting the operability, and management of a self-balancing system that is based on a control moment gyroscope, of a two-wheeler vehicle wherein the first range of safe operating conditions is different than the second range of safe operating conditions.

In one embodiment, the method for detecting the operability, and management of a self-balancing system that is based on a control moment gyroscope, of a two-wheeler vehicle wherein vehicular turn rate is determined using a handle bar orientation sensor.

In one embodiment, the method for detecting the operability, and management of a self-balancing system that is based on a control moment gyroscope, of a two-wheeler vehicle wherein vehicular turn rate is determined by measuring the yaw rate of the vehicle using an Inertial Measurement Unit (IMU).

In one embodiment, the method for detecting the operability, and management of a self-balancing system that is based on a control moment gyroscope, of a two-wheeler vehicle wherein the safe operating conditions is dependent on readiness of the self-balancing system.

In one embodiment, the method for detecting the operability, and management of a self-balancing system that is based on a control moment gyroscope, of a two-wheeler vehicle wherein the safe operating conditions is dependent on achieving threshold speed of the flywheel of the CMG.

In one embodiment, the method for detecting the operability, and management of a self-balancing system that is based on a control moment gyroscope, of a two-wheeler vehicle wherein the steps therein are preceded by checking whether automatic turning ON of self-balancing system is allowed, and allowing the steps to proceed based on positive determination of this condition.

In one embodiment, the method for detecting the operability, and management of a self-balancing system that is based on a control moment gyroscope, of a two-wheeler vehicle wherein the steps therein are preceded by checking whether a user input allows turning ON of self-balancing system and allowing the steps to proceed based on positive determination of this condition.

In one embodiment, the method for detecting the operability, and management of a self-balancing system that is based on a control moment gyroscope, of a two-wheeler vehicle wherein the steps therein are preceded by checking whether a user input instructs turning OFF of self-balancing system in spite of positive determination of conditions under 1e, 1f and 1g.

In one embodiment, the method for detecting the operability, and management of a self-balancing system that is based on a control moment gyroscope, of a two-wheeler vehicle wherein the turning OFF of the self-balancing system involves only stopping the precession of the control moment gyroscope using a stopping device, without stopping the rotation of the flywheel of the control moment gyroscope.

In one embodiment, the method for detecting the operability, and management of a self-balancing system that is based on a control moment gyroscope, of a two-wheeler vehicle wherein the turning ON the self-balancing feature of the self-balancing system is based on a positive determination of one or more of step 1a, 1b and 1c.

In one embodiment, the method for detecting the operability, and management of a self-balancing system that is based on a control moment gyroscope, of a two-wheeler vehicle wherein the turning OFF the self-balancing feature of the self-balancing system is based on a negative result of one or more of step 1e, 1f , and 1g.

In one embodiment, a computer implemented method for detecting the operability, and management of a self-balancing system that is based on a control moment gyroscope, of a two-wheeler vehicle, the method comprising the steps of: intermittently checking, while the two-wheeler vehicle's self-balancing system is OFF, whether a current vehicular velocity is less than a first vehicular velocity threshold; intermittently checking, while the two-wheeler vehicle's self-balancing system is OFF, whether a current vehicle turn rate is less than a first vehicular turn rate; intermittently checking, while the two-wheeler vehicle's self-balancing system is OFF, whether the self-balancing system is within a first range of safe operating conditions for balancing; turning ON the self-balancing feature of the self-balancing system based on a positive determination of step 17a, 17b and 17c; intermittently checking, while the two-wheeler vehicle's self-balancing system is ON, whether the self-balancing system is within a second range of safe operating conditions for balancing; intermittently checking, while the two-wheeler vehicle's self-balancing system is ON, whether a current vehicular velocity is less than a second vehicular velocity threshold; intermittently checking, while the two-wheeler vehicle's self-balancing system is ON, whether a current vehicle turn rate is less than a second vehicular turn rate; and, turning OFF the self-balancing feature of the self-balancing system based on a negative result of step 17e, 17f, or 17g.

In one embodiment, a system for detecting the operability, and management of a self-balancing system that is based on a control moment gyroscope, of a two-wheeler vehicle, comprising: a conditions module configured to receive conditions for various deciding parameters for the operability of said two-wheeler self balancing system; a sensor module configured to sense real-time operating conditions of the two-wheeler self-balancing system and the said two-wheeler; a self-balancing module configured to provide self-balancing feature to the said two-wheeler; and a control unit configured to coordinate between said conditions module, said sensor module and said self-balancing module, wherein the based on the inputs received from the sensor module and based on the conditions specified in the conditions module the control unit is configured to instruct operation of the said self-balancing module.

In one embodiment, the system for detecting the operability, and management of a self-balancing system that is based on a control moment gyroscope, of a two-wheeler vehicle wherein the control unit is configured to receive user input on user desire on operability of the said two-wheeler self-balancing system.

In one embodiment, the system for detecting the operability, and management of a self-balancing system that is based on a control moment gyroscope, of a two-wheeler vehicle wherein the turning OFF of the self-balancing system involves only stopping the precession of the control moment gyroscope using a stopping device, without stopping the rotation of the flywheel of the control moment gyroscope.

### BRIEF DESCRIPTION OF THE ACCOMPANYING DRAWINGS

A clear understanding of the key features of the invention summarized below may be had by reference to the appended drawings, which illustrate the development of an auto balancing device for two wheelers considering safety as well as limiting conditions.

Although it will be understood that such drawings depict preferred embodiments herein and, therefore, are not to be considered as limiting its scope with regard to other embodiments which the invention is capable of contemplating. Accordingly:

FIG. 1 illustrates a block diagram for a system for detecting the operability, and management of a self-balancing system that is based on a control moment gyroscope, of a two-wheeler vehicle, as per an embodiment herein.

FIG. 2 illustrates an exemplary scenario with the assembly of a CMG with flywheel, with stopper device capabilities, integrating innovative aspects disclosed herein, as per an embodiment herein.

FIG. 3 illustrates a method for detecting the operability, and management of a self-balancing system that is based on a control moment gyroscope, of a two-wheeler vehicle, as per an embodiment herein.

FIG. 4 illustrates a method for detecting the operability, and management of a self-balancing system that is based on a control moment gyroscope, of a two-wheeler vehicle, as per an embodiment herein.

### DETAILED DESCRIPTION OF THE INVENTION

A system, and method for detecting the operability, and management of a self-balancing system that is based on a control moment gyroscope, of a two-wheeler vehicle is disclosed. Various real time conditions may be evaluated to allow or disallow the turning ON or OFF, of the self-balancing feature of a self-balancing system when used in a two wheeled vehicle. The self-balancing feature may make use of a control moment gyroscope for providing self balancing. A computer implemented method embodying the teachings is also provided.

The terminology used herein is for the purpose of describing particular embodiments only and is not intended to be limiting of the invention. As used herein, the term “and/or” includes any and all combinations of one or more of the associated listed items. As used herein, the singular forms “a”, “an” and “the” are intended to include the plural forms as well as the singular forms, unless the context clearly indicates otherwise. It will be further understood that the terms “comprises” and/or “comprising”, when used in this specification, specify the presence of stated features, steps, operations, elements, and/or components, but do not preclude the presence or addition of one or more other features, steps, operations, elements, components, and/or groups thereof.

Unless, otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion.

In various embodiments is disclosed a system and method for detecting conditions for: starting a self-balancing feature, and deactivating a self balancing feature; either/both of a vehicle with self-balancing capabilities, and implementation based on the results thereof. In one embodiment the application of such system may lead to creation of a conditional self-balancing system. In another embodiment, this may be added as a safety mechanism to pre-existing self-balancing systems.

The present invention discloses an auto balancing device for two wheelers considering safety as well as limiting conditions.

This invention also aims to solve the challenge of requiring excessive computational systems for balancing a vehicle in various operating conditions.

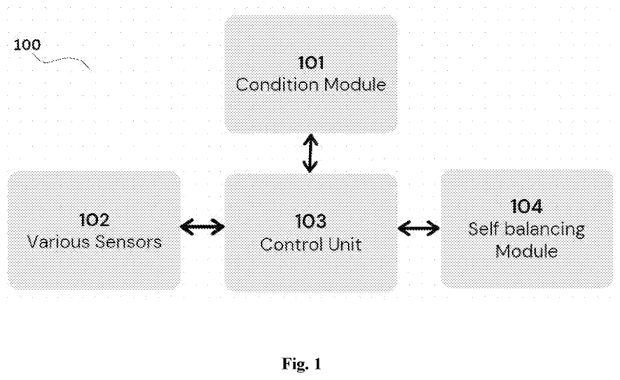

FIG. 1 illustrates a block diagram for a system for detecting the operability, and management of a self-balancing system that is based on a control moment gyroscope, of a two-wheeler vehicle, as per an embodiment herein.

In one embodiment the application of such a system may lead to creation of a conditional self-balancing system.

In the embodiment shown in FIG. 1, the system 100 may comprise of a conditions module 101, communicatively coupled to a control unit 103. The control unit may be the central computational unit of the system. The control unit 103 may be connected with various sensors in sensor module 102. These sensors may be motion, velocity, orientation sensors, that are used to gauge the current or transitions in states of a vehicle. A self balancing module 104 may be the mechanism used for balancing of the vehicle. In an exemplary scenario this may be a CMG based balancing system.

In one embodiment, the conditions module may be configured to receive conditions for various deciding parameters for the operability of said two-wheeler self balancing system. These may be configurable by a user. Further, the sensor module may be configured to sense real-time operating conditions of the two-wheeler self-balancing system and the said two-wheeler. These may comprise of attitude sensors, vehicular velocity sensors, angular turn rate sensor to name a few.

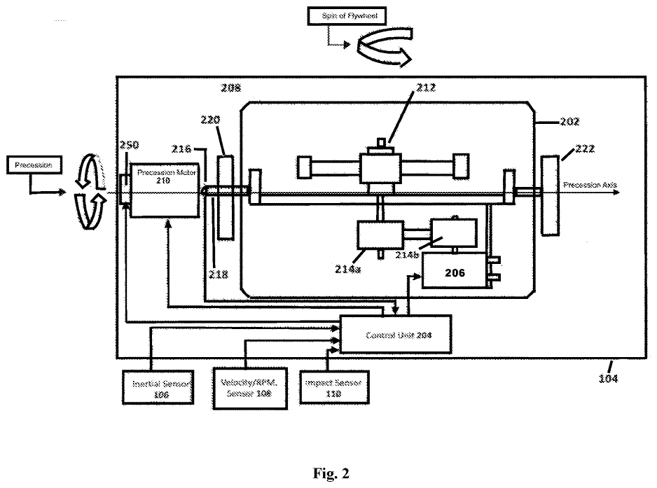

Further, a self-balancing module configured to provide self-balancing feature to the said two-wheeler. This may be as referred to in FIG. 2. Further, a control unit may be configured to coordinate between said conditions module, said sensor module and said self-balancing module, wherein the based on the inputs received from the sensor module and based on the conditions specified in the conditions module the control unit is configured to instruct operation of the said self-balancing module.

Further, in one embodiment, the control unit may be configured to receive user input on user desire on operability of the said two-wheeler self-balancing system. That means that, the self balancing feature may need to be manually allowed to be turned ON. Alternatively, it may not require user input to be allowed to be turned ON.

In one embodiment herein, based on the multiple inputs, the method running on the control unit decides whether to activate or deactivate the self-balancing feature of a vehicle with self-balancing capabilities. The exemplary inputs may include but are not limited to: angular velocity in the yaw direction as detected by the IMU placed on the vehicle; a steering angle sensor if installed on the vehicle, speed of the vehicle, if the precession angle is beyond a certain value. The above conditions may have various logical operators between them in an exemplary embodiment. Alternatively, any of the conditions may need to be satisfied. If the stopper is dis-engaged the CMG is maneuvered for Balancing the vehicles else no inputs are given to CMG.

In one embodiment, the turning OFF of the self-balancing system may involve only stopping the precession of the control moment gyroscope using a stopping device, without stopping the rotation of the flywheel of the control moment gyroscope hence keeping the CMG ready for action when in need, but keeping the precession action thereof OFF to disallow negative aspects of CMG, when not in need.

FIG. 2 illustrates an exemplary scenario with the assembly of a CMG with flywheel, with stopper device capabilities, integrating innovative aspects disclosed herein, as per an embodiment herein.

In one embodiment herein, a control moment gyroscope 202 may be provided, having a precession shaft 218 that may have a flywheel coupled thereto. The control moment gyroscope may contribute in balancing the vehicle where it may be installed. In another embodiment more than one control moment gyroscope may be provided. Further, a stopper device 250 may be provided coupled to the precession shaft that when signaled as such engages the precession shaft to stop the rotation of the precession shaft. In one embodiment, the stopper device may be realized using electromechanical parts. Some examples may include electromagnetic mechanism, electric mechanism, friction mechanism, hydraulic mechanism, servo mechanisms, pneumatic/air mechanism, vacuum mechanism. Further, designs of such stopper mechanisms may include a disc or a drum brake. This stopper device may allow the flywheel of a CMG to continue rotating in speeds required to keep it ready for instantaneous use, while still keeping precession activity of the balancing module at a standstill. In such scenarios, CMG can be deactivated such that it does not provide the balancing torques to the vehicle. The activation/deactivation can be done via a switch operated by the rider. It can also be done automatically to ensure a seamless experience for the rider, than to use their judgment to evaluate when to enable/disable the self-balancing module.

In one embodiment the control moment gyroscope may comprise of a flywheel 208 rotating around a flywheel shaft 212. The flywheel may rotate in a first direction which may be clockwise or anticlockwise. A means for rotating the flywheel may be provided in form of a spin motor 206. The spin motor 206 may spin the flywheel either directly or through one or more pulley system that may further comprise of a driven pulley 214a and a driver pulley 214b. When spinning the flywheel directly, the spin motor may be mounted directly on the flywheel shaft 212 or be integrated with the flywheel shaft. The flywheel, flywheel shaft and the spin motor may be integrated into one unit as well. For the flywheel to operate as intended there may be a velocity of rotation defined. This threshold flywheel-spin-velocity may vary depending on various factors including the weight of the flywheel and vehicle, including others.

In one embodiment, the control unit may be preconfigured to have the intelligence provided in the condition module of FIG. 1. In another embodiment a preexisting control unit may be equipped with the condition module.

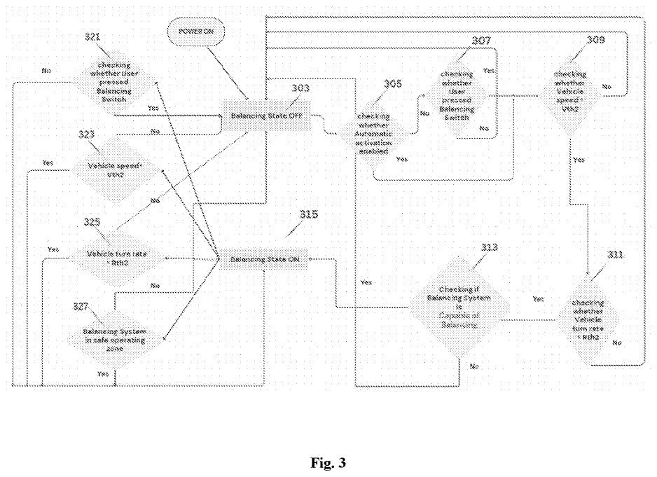

FIG. 3 illustrates a method for detecting conditions for: starting a self-balancing feature; and deactivating a self balancing feature of a vehicle with self-balancing capabilities, and implementation based on the results thereof, as per an embodiment herein.

As per an embodiment the method involves checking various parameters for activating and deactivating a self-balancing feature of a vehicle with self balancing capabilities. In an exemplary scenario shown in FIG. 3 the method may comprise the steps as enumerated below. A person skilled in the art may realize that the sequence of some steps herein may be altered without deviating from the essence of the invention.

In the exemplary embodiment shown in FIG. 3, we may have a user manual switch that may be used for switching on a self balancing feature. In another embodiment the self balancing may be achieved by a CMG based system. In yet another embodiment, the switching on and off of a self-balancing feature may be achieved with the help of a stopper device. This stopper device may allow the flywheel of a CMG to continue rotating in speeds required to keep it ready for instantaneous use, while still keeping precession activity of the balancing module at a standstill. Further, the steps herein may be operating intermittently, independently, or depending on a trigger as disclosed herein.

In one embodiment, the steps may include receiving a trigger to switch on the system. In one embodiment this may be user induced, in another this may be automated based on meeting of certain conditions. The default during power ON may be kept to be such that the self-balancing feature is OFF 303. As a next step checking 305 whether the automatic activation has been enabled by the user is undertaken. The method does not proceed if the user has not activated this feature and intermittently keeps checking 307 for an input from a user. If the self balancing feature has been enabled by the user the method proceeds to check if the vehicle speed is less than a set threshold Vth. Vth may indicate the vehicle speed beyond which self balancing may not be activated. Upon receiving a positive response to the checking in step 309, vehicle turn rate may be checked 311 for a value being less than a threshold turn rate Rₜₕ This check may be done using handle bar orientation sensor exemplarily. Other turn sensing mechanisms such as measuring the yaw rate of the vehicle using an Inertial Measurement Unit (IMU) placed on the vehicle may also be used. This way a vehicle that is turning directions drastically would have its self-balancing disabled.

In an embodiment, further step may involve checking for capability of the balancing system for balancing. This may internally involve checking with a control unit that keeps information about the readiness of the self-balancing module. An aspect of readiness of the self-balancing module may be with regards to achieving threshold speed of the flywheel of the CMG. The control unit may have other factors deciding readiness of the self-balancing system. e.g. in a CMG module as the precession angle of the flywheel approaches certain values their capability of generating roll torque reduces and may not be sufficient for balancing the vehicle. On positive determination of the readiness of the self-balancing module the self-balancing feature may be turned on 315.

In an embodiment, upon switching ON of the self-balancing feature a periodic intermittent determination of following factors may take place. 1. Vehicle speed being 323 less than a threshold Vₜₕ₂ 2. Vehicle turn rate being 325 less than Rₜₕ₂, 3. Balancing system safe operation 327, 4. User manually switching OFF the self-balancing feature 321. If the answer to any of the first 3 determinations are negative or the determination of the fourth condition is positive the balancing state is turned off. Otherwise the balancing system continues to remain in ON State.

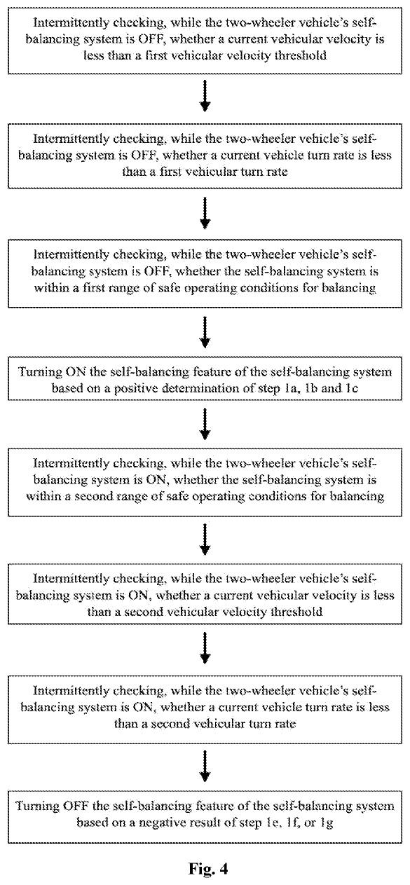

FIG. 4 illustrates a method for detecting the operability, and management of a self-balancing system that is based on a control moment gyroscope, of a two-wheeler vehicle, as per an embodiment herein. This may be a simple representation of a method, for easier understanding of the person skilled in the art. This may also be implemented as a computer implemented method so as to be transferable to a general control system of a two-wheeled vehicle.

In one embodiment, the method may involve intermittently checking, while the two-wheeler vehicle's self-balancing system is OFF, whether a current vehicular velocity is less than a first vehicular velocity threshold. This may be done to allow for self-balancing feature to run only below certain vehicular velocities. In one embodiment, the method may involve intermittently checking, while the two-wheeler vehicle's self-balancing system is OFF, whether a current vehicle turn rate is less than a first vehicular turn rate. This may allow for disallowing self balancing when the vehicle is turning beyond a certain threshold angle (indicated by angular turn rate). This may be since, the turn may be user induced, or desired. The self balancing feature may be acting against such wish, if it operates to bring vehicle to upright position. In one embodiment, the method may involve intermittently checking, while the two-wheeler vehicle's self-balancing system is OFF, whether the self-balancing system is within a first range of safe operating conditions for balancing. In one embodiment, a step may direct turning ON the self-balancing feature of the self-balancing system based on a positive determination of step 1a, 1b and 1c. In one embodiment, all the three conditions need to be met before turning ON the self-balancing feature. In another embodiment, the turning ON of the self balancing feature may happen based on positive determination of one or more of the conditions of vehicular velocity, vehicular turn rate, and safety conditions of the self balancing system. Also, the order of checking the three conditions is not necessarily one after the other. Hence, they may be done in parallel as well or in any order that deems fit.

In one embodiment, the vehicular turn rate may be determined by measuring the yaw rate of the vehicle using an Inertial Measurement Unit (IMU), while in another, using a handle bar orientation sensor.

In one embodiment, the method may involve intermittently checking, while the two-wheeler vehicle's self-balancing system is ON, whether the self-balancing system is within a second range of safe operating conditions for balancing. This may be done to keep checking for conditions to turn ON the self balancing system. Further, intermittently checking, while the two-wheeler vehicle's self-balancing system is ON, whether a current vehicular velocity is less than a second vehicular velocity threshold, may take place. Further, intermittently checking, while the two-wheeler vehicle's self-balancing system is ON, whether a current vehicle turn rate is less than a second vehicular turn rate, may take place. In one embodiment, turning OFF the self-balancing feature of the self-balancing system based on a negative result of step 1e, 1f , or 1g may take place.

In one embodiment, ser may be provided an option to turn OFF self-balancing even if all the conditions are positive. Accordingly, a step may include checking intermittently for user turning off the self-balancing even if all the conditions for self-balancing feature are met.

In one embodiment, the safe operating conditions may be dependent on readiness of the self-balancing system. One example may be achieving threshold speed of the flywheel of the CMG. The range of operation that may be considered safe could be flywheel speed of a certain RPM.

In one embodiment, any of the conditions for turning OFF of the self balancing feature need to be met. That is to say have negative outcomes, to turn the self balancing feature OFF. However, in another embodiment, this may be done based on negative determination of one or more of these conditions.

Further, in one embodiment, for turning ON of the self balancing feature, the thresholds of vehicular velocity, vehicular turn rate and range of safe operating conditions may be kept different than those for turning it OFF. This may be done to allow for a safe range of operations for control systems. In another embodiment, these may be kept same or almost similar. Hence, a first vehicular velocity threshold may be same or similar to second vehicular velocity threshold. Similarly, a first vehicular turn rate may be same or similar to second vehicular turn rate. These may apply to safety conditions for self-balancing system as well.

The system and method as enumerated above allows use of self-balancing feature in predetermined situations. This may be programmed based on the capability of the self-balancing system, operating conditions, processing power and the like. The conditions-check method enumerated herein allows users the peace of mind that, the switching ON the self-balancing system at a time that it's unsafe to do so would not enable self-balancing. This increases the scope of the use of this technology. Further manual switching ON and OFF based on user judgment alone may be eliminated, thus increasing safety. One may note that the system allows for an additional layer of safety since it allows user to provide their willingness to start or stop self-balancing over and above system level check of conditions for self-balancing.

I/We claim:

1. A method for detecting the operability, and management of a self-balancing system that is based on a control moment gyroscope, of a two-wheeler vehicle, the method comprising the steps of:
a. intermittently checking, while the two-wheeler vehicle's self-balancing system is OFF, whether a current vehicular velocity is less than a first vehicular velocity threshold;
b. intermittently checking, while the two-wheeler vehicle's self-balancing system is OFF, whether a current vehicle turn rate is less than a first vehicular turn rate;
c. intermittently checking, while the two-wheeler vehicle's self-balancing system is OFF, whether the self-balancing system is within a first range of safe operating conditions for balancing;
d. turning ON the self-balancing feature of the self-balancing system based on a positive determination of step 1a, 1b and 1c;
e. intermittently checking, while the two-wheeler vehicle's self-balancing system is ON, whether the self-balancing system is within a second range of safe operating conditions for balancing;
f. intermittently checking, while the two-wheeler vehicle's self-balancing system is ON, whether a current vehicular velocity is less than a second vehicular velocity threshold;
g. intermittently checking, while the two-wheeler vehicle's self-balancing system is ON, whether a current vehicle turn rate is less than a second vehicular turn rate; and,
h. turning OFF the self-balancing feature of the self-balancing system based on a negative result of step 1e, 1f , or 1g.

2. The method for detecting the operability, and management of a self-balancing system that is based on a control moment gyroscope, of a two-wheeler vehicle, as in claim 1, wherein the first vehicular turn rate is same as second vehicular turn rate.

3. The method for detecting the operability, and management of a self-balancing system that is based on a control moment gyroscope, of a two-wheeler vehicle, as in claim 1, wherein the first vehicular turn rate is different that the second vehicular turn rate.

4. The method for detecting the operability, and management of a self-balancing system that is based on a control moment gyroscope, of a two-wheeler vehicle, as in claim 1, wherein the first vehicular velocity threshold is same as second vehicular velocity threshold.

5. The method for detecting the operability, and management of a self-balancing system that is based on a control moment gyroscope, of a two-wheeler vehicle, as in claim 1, wherein the first vehicular velocity threshold is different that the second vehicular velocity threshold.

6. The method for detecting the operability, and management of a self-balancing system that is based on a control moment gyroscope, of a two-wheeler vehicle, as in claim 1, wherein the first range of safe operating conditions is same as the second range of safe operating conditions.

7. The method for detecting the operability, and management of a self-balancing system that is based on a control moment gyroscope, of a two-wheeler vehicle, as in claim 1, wherein the first range of safe operating conditions is different than the second range of safe operating conditions.

8. The method for detecting the operability, and management of a self-balancing system that is based on a control moment gyroscope, of a two-wheeler vehicle, as in claim 1, wherein vehicular turn rate is determined using a handle bar orientation sensor.

9. The method for detecting the operability, and management of a self-balancing system that is based on a control moment gyroscope, of a two-wheeler vehicle, as in claim 1, wherein vehicular turn rate is determined by measuring the yaw rate of the vehicle using an Inertial Measurement Unit (IMU).

10. The method for detecting the operability, and management of a self-balancing system that is based on a control moment gyroscope, of a two-wheeler vehicle, as in claim 1, wherein the safe operating conditions is dependent on readiness of the self-balancing system.

11. The method for detecting the operability, and management of a self-balancing system that is based on a control moment gyroscope, of a two-wheeler vehicle, as in claim 1, wherein the safe operating conditions is dependent on achieving threshold speed of the flywheel of the CMG.

12. The method for detecting the operability, and management of a self-balancing system that is based on a control moment gyroscope, of a two-wheeler vehicle, as in claim 1, wherein the steps therein are preceded by checking whether automatic turning ON of self-balancing system is allowed, and allowing the steps to proceed based on positive determination of this condition.

13. The method for detecting the operability, and management of a self-balancing system that is based on a control moment gyroscope, of a two-wheeler vehicle, as in claim 1, wherein the steps therein are preceded by checking whether a user input allows turning ON of self-balancing system and allowing the steps to proceed based on positive determination of this condition.

14. The method for detecting the operability, and management of a self-balancing system that is based on a control moment gyroscope, of a two-wheeler vehicle, as in claim 1, wherein the steps therein are preceded by checking whether a user input instructs turning OFF of self-balancing system in spite of positive determination of conditions under 1e, 1f and 1g.

15. The method for detecting the operability, and management of a self-balancing system that is based on a control moment gyroscope, of a two-wheeler vehicle, as in claim 1, wherein the turning OFF of the self-balancing system involves only stopping the precession of the control moment gyroscope using a stopping device, without stopping the rotation of the flywheel of the control moment gyroscope.

16. The method for detecting the operability, and management of a self-balancing system that is based on a control moment gyroscope, of a two-wheeler vehicle, as in claim 1, wherein the turning ON the self-balancing feature of the self-balancing system is based on a positive determination of one or more of step 1a, 1b and 1c.

17. The method for detecting the operability, and management of a self-balancing system that is based on a control moment gyroscope, of a two-wheeler vehicle, as in claim 1, wherein the turning OFF the self-balancing feature of the self-balancing system is based on a negative result of one or more of step 1e, 1f , and 1g.

18. A computer implemented method for detecting the operability, and management of a self-balancing system that is based on a control moment gyroscope, of a two-wheeler vehicle, the method comprising the steps of:
a. intermittently checking, while the two-wheeler vehicle's self-balancing system is OFF, whether a current vehicular velocity is less than a first vehicular velocity threshold;
b. intermittently checking, while the two-wheeler vehicle's self-balancing system is OFF, whether a current vehicle turn rate is less than a first vehicular turn rate;
c. intermittently checking, while the two-wheeler vehicle's self-balancing system is OFF, whether the self-balancing system is within a first range of safe operating conditions for balancing;
d. turning ON the self-balancing feature of the self-balancing system based on a positive determination of step 17a, 17b and 17c;
e. intermittently checking, while the two-wheeler vehicle's self-balancing system is ON, whether the self-balancing system is within a second range of safe operating conditions for balancing;
f. intermittently checking, while the two-wheeler vehicle's self-balancing system is ON, whether a current vehicular velocity is less than a second vehicular velocity threshold;
g. intermittently checking, while the two-wheeler vehicle's self-balancing system is ON, whether a current vehicle turn rate is less than a second vehicular turn rate; and,
h. turning OFF the self-balancing feature of the self-balancing system based on a negative result of step 17e, 17f, or 17g.

19. A system for detecting the operability, and management of a self-balancing system that is based on a control moment gyroscope, of a two-wheeler vehicle, comprising:
a. a conditions module configured to receive conditions for various deciding parameters for the operability of said two-wheeler self balancing system;
b. a sensor module configured to sense real-time operating conditions of the two-wheeler self-balancing system and the said two-wheeler;
c. a self-balancing module configured to provide self-balancing feature to the said two-wheeler; and
d. a control unit configured to coordinate between said conditions module, said sensor module and said self-balancing module, wherein the based on the inputs received from the sensor module and based on the conditions specified in the conditions module the control unit is configured to instruct operation of the said self-balancing module.

20. The system for detecting the operability, and management of a self-balancing system that is based on a control moment gyroscope, of a two-wheeler vehicle, as in claim 19, wherein the control unit is configured to receive user input on user desire on operability of the said two-wheeler self-balancing system.

21. The system for detecting the operability, and management of a self-balancing system that is based on a control moment gyroscope, of a two-wheeler vehicle, as in claim 19, wherein the turning OFF of the self-balancing system involves only stopping the precession of the control moment gyroscope using a stopping device, without stopping the rotation of the flywheel of the control moment gyroscope.
